(19) United States
(12) Patent Application Publication
(10) Pub. No.: US 2010/0232747 A1
(43) Pub. Date: Sep. 16, 2010

(54) Assembly With An Optical Fiber Alignment

(76) Inventors: Jeroen Duis, Didam (NL); Jacob Arie Elenbaas, Heyningen (NL); Peter Dirk Jaeger, Dussen (NL)

Correspondence Address: BARLEY SNYDER, LLC, 1000 WESTLAKES DRIVE, SUITE 275, BERWYN, PA, 19312, US

(21) Appl. No.: 12/722,049

(22) Filed: Mar. 11, 2010

(30) Foreign Application Priority Data
Mar. 16, 2009 (EP) 09155217.4

(51) Int. Cl. G02B 6/36

(52) U.S. Cl. 385/78

(57) ABSTRACT

The invention refers to an optical fiber connector with a support member and a ferrule for receiving an optical fiber and fixed to the support member. The optical fiber is embedded in the ferrule. An end face of the optical fiber is arranged on the support member, while an alignment element is connected with the support member. The end face of the optical fiber abuts with the alignment element, whereby the alignment element aligns the end face of the optical fiber relative to a predetermined optical path.

### CROSS-REFERENCE TO RELATED APPLICATIONS

This application claims the benefit of the filing date under 35 U.S.C. §119(a)-(d) of European Patent Application No. EP 09155217.4 of Mar. 16, 2009.

### FIELD OF THE INVENTION

The invention is an optical connector, and in particular, an optical fiber connector having a support member with a ferrule and an optical fiber embedded in the ferrule.

### BACKGROUND

Connectors having a support member with a ferrule and an optical fiber embedded in the ferrule are an essential part of substantially all optical fiber communication systems. For instance, these connectors used for joining segments of fiber to obtain longer lengths, for connecting fibers to active devices such as radiation sources, detectors and repeaters, and to connect fibers to passive devices such as switches and attenuators.

A basic function of the connector is to hold an optical fiber in such a way that its core is actually aligned with the optical path of the device to which the optical fiber connects. Thus, the light from the fiber is optimally coupled to the optical path of the related optical device.

For aligning the optical fiber to a predetermined optical path, the ferrule is fixed by a retaining element in a predetermined position. However, this solution is not always sufficient.

U.S. Pat. No. 7,441,963 B2 describes an optical device having a guide with a ferrule for an optical fiber, whereby the end face of the fiber and the guide include faces that fit together.

There is a need for an optical fiber connector having a ferrule with an optical fiber that has an improved alignment of the optical fiber.

### SUMMARY

The invention is a connector having a support member with a ferrule with an optical for receiving a fiber that provides a more precise alignment of the optical fiber referring to an optical path.

The connector includes a support member, a ferrule, and an alignment element. The ferrule is for receiving an optical fiber and is fixed to the support member. The alignment element connects with the support member, while abutting an end face of the optical fiber. A guiding face of an opening of the alignment element includes a first section with a tapered shape and cross section and abuts a surface of the end face of the optical fiber. The tapered shape and cross section narrows in an inserting direction of the end face of the optical fiber.

### BRIEF DESCRIPTION OF THE DRAWINGS

Embodiments of the invention are described in greater detail in the following description and are shown in a simplified manner in the drawings, in which:

FIG. 1 shows a perspective view of an optical fiber connector:

FIG. 2 shows a cross-sectional view of the optical fiber connector, from the side;

FIG. 3 shows a cross-sectional view of the optical fiber connector, from the top;

FIG. 4 shows a detailed sectional view of the end face of the optical fiber of FIG. 3;

FIG. 5 shows a front perspective view of the alignment element;

FIG. 6 depicts a backside perspective view of the alignment element;

FIG. 7 shows a supporting member with a clamping element;

FIG. 8 shows another embodiment of an optical fiber connector with a mounted ferrule for an optical fiber;

FIG. 9 shows a connector tool;

FIG. 10 shows the connector tool with a smaller optical fiber;

FIG. 11 shows a further embodiment of a support member;

FIG. 12 shows a further embodiment of a ferrule;

FIG. 13 shows a cross-section of a pre-assembled ferrule;

FIG. 14 shows a further cross-section of the pre-assembled ferrule;

FIG. 15 shows a cross-section of an assembled optical fiber;

FIG. 16 shows a detail of FIG. 15;

FIG. 17 shows a further cross-section of FIG. 15; and

FIG. 18 shows another cross-section of FIG. 15.

### DETAILED DESCRIPTION OF THE EMBODIMENT(S)

Hereinafter, embodiments of the invention will be described with reference to the drawings.

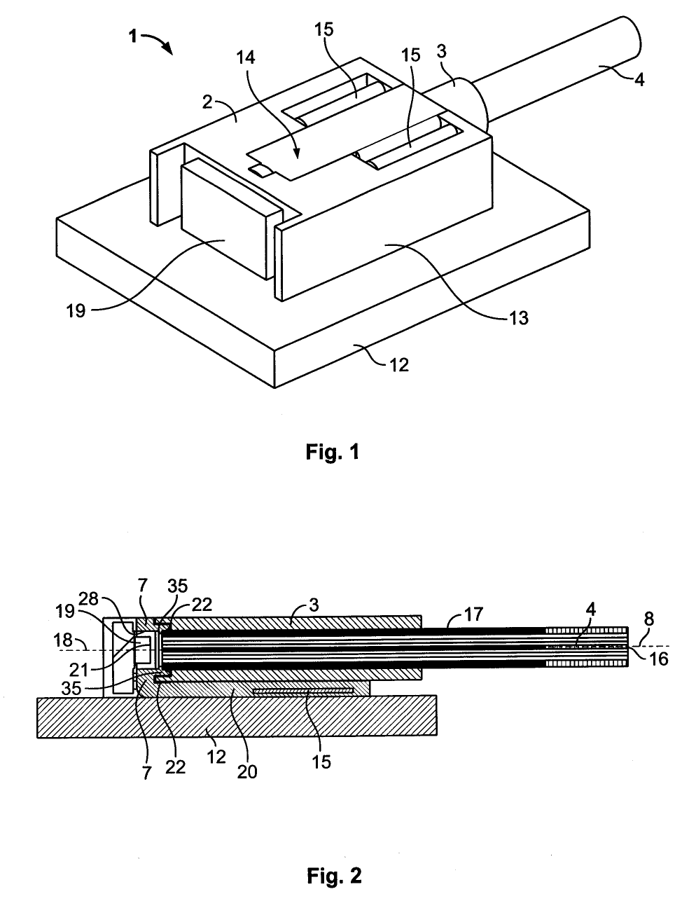

With respect to FIG. 1, an optical fiber connector 1 is shown having a support member 2 and a ferrule 3 for receiving an optical fiber 4. The optical fiber 4 may be embodied as a single fiber or multi-fiber. The exemplary embodiment is a multi-fiber. Furthermore, an optical component 19 is disposed that is optically connected with the optical fiber 4. The support member 2 includes a plate 12 with a housing 13 that is arranged on the plate 12. The housing 13 includes a ferrule recess 14 with an opening at the upper side of the housing 13. The end of the ferrule 3 is disposed in the ferrule recess 14. A clamping element 15 is arranged in the ferrule recess 14 and fixes the ferrule 3 in a detachable manner with the support member 2.

FIG. 2 shows a first cross-sectional view of the optical fiber connector 1 in a first plane along an x-x section of the longitudinal middle axis of the optical fiber 4, which is perpendicular to the plate 12. The optical fiber 4 includes a core 16 that is arranged along the longitudinal axis 8 of the optical fiber 4. In the shown embodiment, the core 16 is realized as a bundle of optical fibers. In a further embodiment, the core 16 may be realized as single optical fiber.

The core 16 is surrounded by a cladding 17 that envelopes the outer face of the core 16. The optical fiber 4 is embedded with an end section in the ferrule 3. The longitudinal axis 8 is in line with a predetermined optical path 18 of the optical component 19 that is advantageous for an effective optical coupling with the optical fiber 4.

The housing 13 includes a base plate 20 that is arranged on the upper face of the plate 12. The base plate 20 is connected with an alignment element 7 that is disposed as a vertical plate. Depending on the embodiment, the clamping element 15 may be embedded with a base element in the base plate 20.

The alignment element 7 includes an opening, or bore 21, whereby the optical fiber 4 protrudes with an end face in the bore 21. Furthermore, a front end of the ferrule 3 includes an alignment passageway 22 adjacent to the surface of the optical fiber 4. Protruding parts 35 of the alignment element 7 extend in the alignment passageway 22 directly abutting at the surface of the cladding 17 or the surface of the core 16.

Furthermore, the optical component 19 is at least partly arranged within an optical component recess 28 of the alignment element 7 at an opposite side compared to the bore 21. The bore 21 passes in the optical component recess 28.

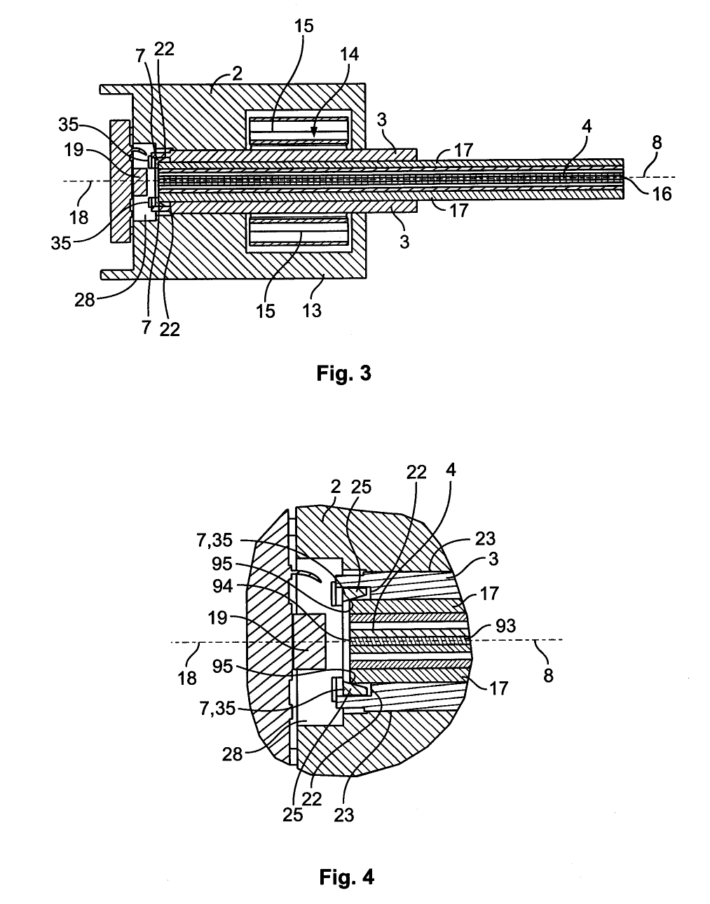

As shown in FIG. 3, the optical fiber connector 1 is positioned in a second plane y-y, which is in the longitudinal axis 8 and which is parallel to the base plate 20. As can be seen from FIG. 3, the ferrule 3 is clamped by the clamping element 15 at two opposite sides.

With respect to FIG. 4, the ferrule 3 is aligned by opposite walls 23 of the support member 2. Furthermore, the ferrule 3 includes the alignment passageway 22 adjacent to the optical fiber 4. In the embodiment shown, the alignment passageway 22 has the shape of a circular ring adjacent to the surface of the cladding 17. The alignment element 7 protrudes with the protruding parts 35 in the alignment passageway 22. The protruding parts 35 have in this embodiment the shape of a circular ring. The protruding parts 35, i.e. circular ring of the alignment element 7, encompasses the cladding 17 of the optical fiber 4. The protruding parts 35 includes at an inner face a first section 25 (e.g. circular), which has a conical or tapered cross-section along the longitudinal axis 8 of the optical fiber 4. The cross-section of the first section 25 decreases in the direction to the optical component 19. The optical fiber 4 has a surface 94 that abuts with a circular outer rim 95 at the first section 25. The first section 25 is used for aligning the optical fiber 4 by introducing the optical fiber 4 in the bore 21. By introducing the optical fiber 4 in the bore 21, the end face 93 of the optical fiber 4 is guided by the first section 25. Therefore, the optical fiber 4 has a very precise position referring to the optical path 18, which is along a middle axis of the bore 21. The optical component 19 is aligned to the optical path 18. The optical component 19 is at least partially arranged in the optical component recess 28 of the alignment element 7. Thus, a compact connector assembly is provided.

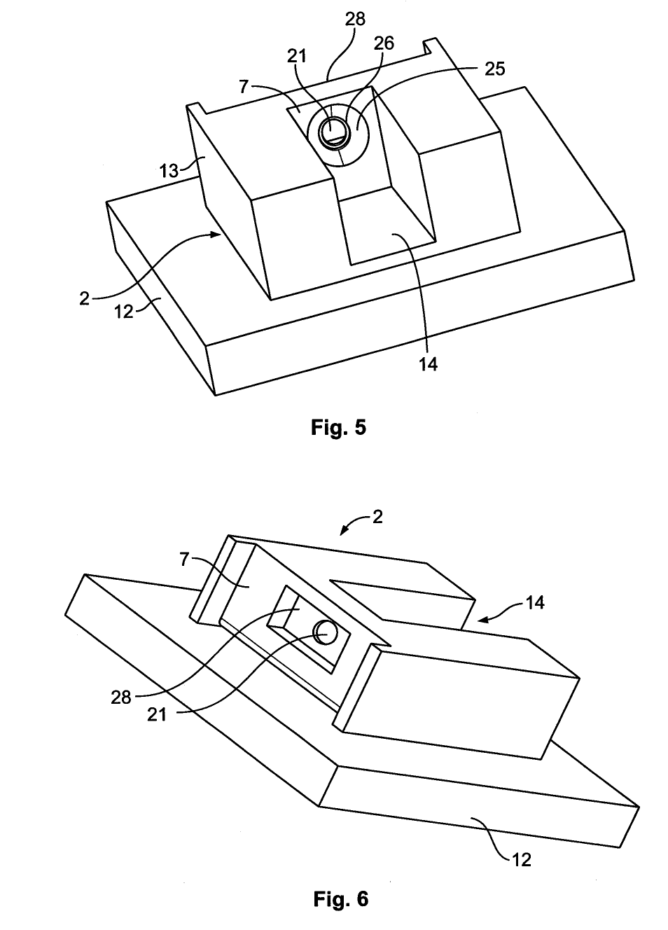

Turning now to FIG. 5, the bore 21 including the first section 25, being conical in the embodiment shown, which passes over to a second section 26, being a cylindrical shape in the embodiment shown. The second section 26 surrounds a reduced open diameter of the bore 21 that passes over to the optical component recess 28. Depending on the embodiment, the first section 25 may be guided through the whole thickness of the alignment element 7 without disposing into a second section 26.

FIG. 6 depicts a backside of the alignment element 7 with a view on the optical component recess 28 in which the bore 21 passes over.

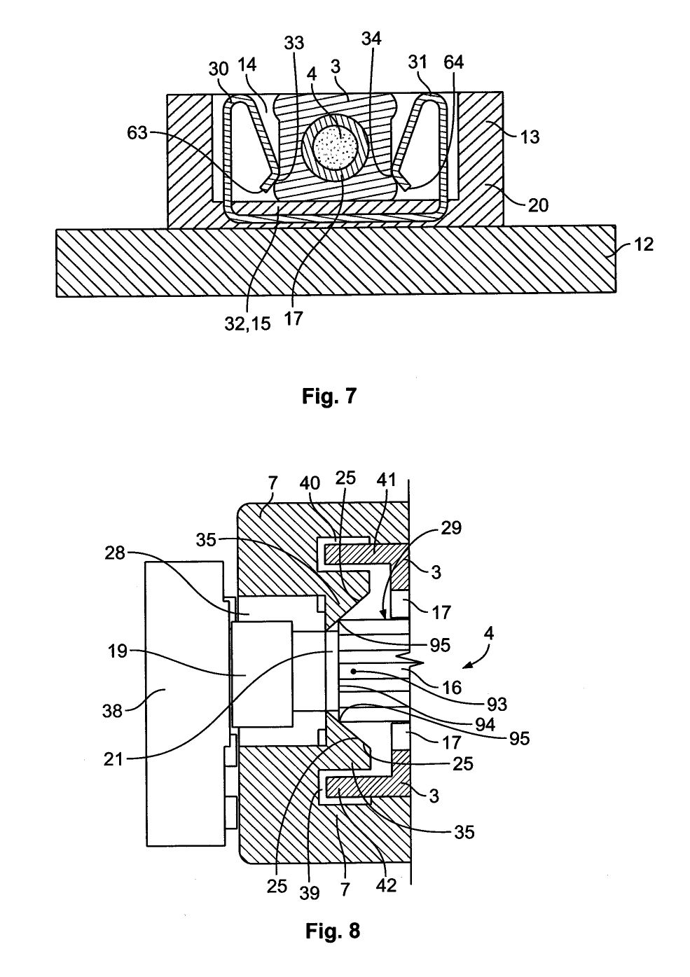

FIG. 7 is a further cross-sectional view of the optical fiber connector 1, whereby the cross-sectional view is arranged perpendicular to the longitudinal axis 8 of the optical fiber 4 in the region of the clamping element 15. The clamping element 15 basically has a U-shape, whereby a first and second U-shaped arms 30, 31 are connected by a middle section 32. The middle section 32 is arranged in the base plate 20 or connected with the base plate 20. At two opposite sides of the middle section 32, a first and second U-shaped arm 30, 31 is connected with a middle section 32. A first part of the first and second U-shaped arm 30, 31 is arranged perpendicular to the middle section 32 and guided up to a plane in a region of an upper face of the support member 2. Starting from the plane, the first and second U-shaped arms 30, 31 are bent back to the middle section 32 in the direction of the middle section 32. Bent ends 63, 64 of the first and second U-shaped arms 30, 31 are bent back to the outer part of the first and second U-shaped arms 30, 31. The clamping element 15 provides a simple and cheap means for fixing the ferrule 3.

The ferrule 3 includes a cross-sectional shape of a rectangle, whereby at two opposite side walls, inclined faces 33, 34 are disposed in the lower section of the side walls. The inclined faces 33, 34 are inclined outwards in the direction of a bottom of the ferrule that rests on the base plate 20. The bent ends 63, 64 of the first and second U-shaped arms 30, 31 engage the first and the second inclined face 33, 34, respectively. Thus, it is possible, by using the clamping element 15, to urge the ferrule 3 toward the base plate 20 of the support member 2. This provides a strong fixation of the ferrule 3 and due to the shape of the first and second U-shaped arms 30, 31 with the bent ends 63, 64 an easy mounting of the ferrule 3.

Turning now to the embodiment shown in FIG. 8, a front end of the ferrule 3 projects with a first and a second projection 41, 42 beyond the front face of the end face 93 of the optical fiber 4. The alignment element 7 includes a first and a second recess 39, 40, which are arranged to receive the first and the second projection 41, 42 of the ferrule 3. During the assembling of the optical fiber 4, the first and the second projection 41, 42 are moved in the first and the second recess 39, 40, resulting in a rough alignment of the ferrule 3. This rough alignment results in a pre-alignment of an end face 93 of the optical fiber 4 within the first section 25. The end face 93 of the optical fiber 4 includes a surface 94 that abuts with at least a part of a circular outer rim 95, on the first section 25. The first section 25 is shaped as a tapered or conical section as explained with reference to FIG. 5. Depending on the embodiment, it is not necessary that the whole surface 94 of the end face 93 of the fiber 4 is a plane face. For a precise alignment it might be sufficient if at least an outer rim 95 of the surface 94 of the end face 93 of the optical fiber 4 is a plane ring face. During the insertion of the optical fiber 4 in the bore 21, the optical fiber 4 is aligned by the first section 25 and abutting in an end position on the first section 25. Using the rough alignment, by the first and the second recess 39, 40 of the alignment element 7 with the first and the second projections 42, 41 of the ferrule 3, reduces the danger of damaging the sensitive end face 93 of the optical fiber 4. The optical fiber 4 is constructed as a multi-fiber with several single fibers within the optical fiber 4. The optical fiber 4 is aligned by the surface of the optical fiber 4, whereby the cladding 17 is stripped off in an end section 29 of the end face 93 of the optical fiber 4.

The optical component 19 is arranged within the optical component recess 28, whereby the optical component 19 is fixed on a printed circuit board 38, which is adjacent at a backside of the alignment element 7. The optical component 19 may be for example a laser diode, such as a vertical cavity surface emitting laser diode. Depending on the embodiment, the optical component 19 could also be an optical sensor or an optical connector element or an optical guiding element, such as an optical fiber 4.

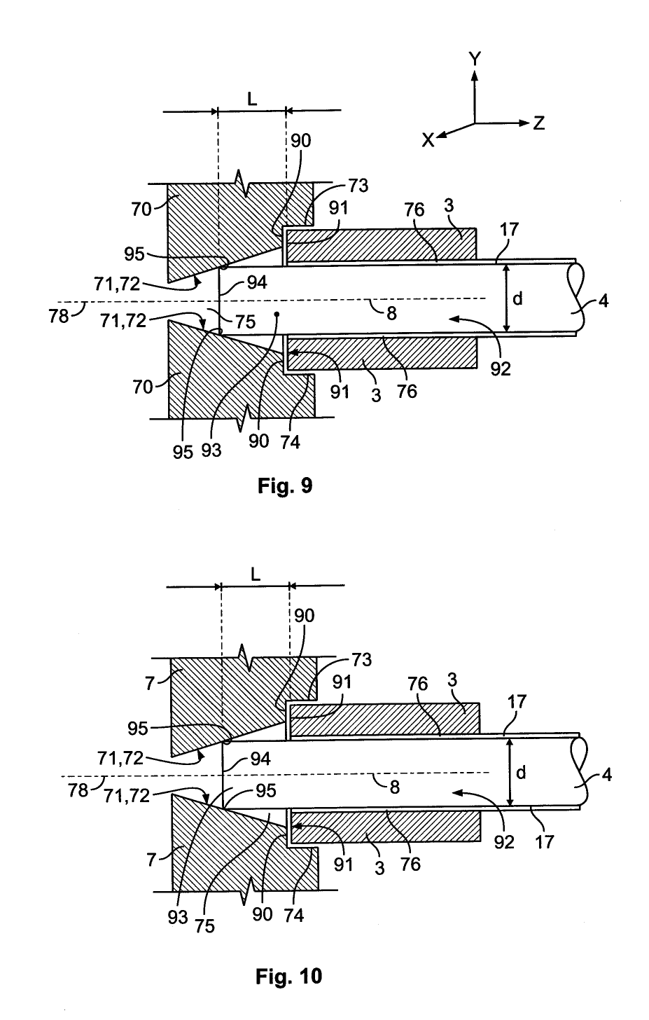

In the embodiment shown in FIG. 9, the conical or tapered section 72 has the same shape and the same size as the first section 25 of the alignment element 7. The ferrule 3 is aligned by assembly faces 73, 74, that encompass the ferrule 3 in a front end section. Furthermore, the ferrule 3 is pushed with a second stop shoulder 91 against a first stop shoulder 90 of the alignment tool 70 defining a predetermined distance between the tapered section 72 and a front of the ferrule 3. The predetermined distance is the same distance which the mounted ferrule 3 has in the mounted position with respect to the first section 25 of the alignment element 7. Therefore, the ferrule 3 is aligned in parallel to a middle axis 78 of the receiving space 75 of the alignment tool 70. The optical fiber 4 is pushed from a back side through an receiving passageway 92 of the ferrule 3 towards the alignment tool 70. The optical fiber 4 is aligned by the alignment face 71, whereby an outer rim 95 of a surface 94 of the end face 93 of the optical fiber 4 abuts at the conical or tapered section 72. The optical fiber 4 is not yet fixed with the ferrule 3 and can be moved along the z-axis in the receiving passageway 92 of the ferrule 3. Following the alignment of the optical fiber 4 in the alignment tool 70, the optical fiber 4 is fixed to the ferrule 3, e.g. by means of a glue 76 or by means of welding. This assembling method has the advantage that the end face 93 of the optical fiber 4 projects at a predetermined distance from a front of the ferrule 3 to get into contact with the tapered section 72. The alignment tool 70 has the advantage that the mounting of the optical fiber 4 is carried out precisely since the surface 94 of the end face 93 of the optical fiber 4 abuts against the tapered section 72, which is conical. Therefore, the longitudinal axis 8 of the fiber is in line with the middle axis 78, whereby the conical section 72 is arranged symmetrically to the middle axis. The optical fiber 4 is a single fiber or a bundle of fibers.

In FIG. 10, the alignment tool 70 is shown with a ferrule 3 and an optical fiber 4 having a smaller diameter compared to the optical fiber 4 of FIG. 9. Because of the smaller diameter of the optical fiber 4, the optical fiber 4 is introduced with a greater length L in the receiving space 75 of the alignment tool 70. Also in this embodiment, the optical fiber 4 abuts against the conical section 72 of the receiving space 75 with an outer rim 95 of the surface 94 of the end face 93. The advantage of using a conical section 72 for aligning the length of the distance L that protrudes the end face 93 of the optical fiber 4 from the ferrule 3 is that there is a precise alignment of the middle longitudinal axis 8 of the optical fiber 4 with respect to the middle axis 78 that represents a predetermined optical path 18. By using the alignment tool 70, a ferrule 3 with an aligned mounted optical fiber 4 is attained. The end face 93 of the optical fiber 4 projects from the front of the ferrule 3 with a predetermined distance L that depends on the diameter of the optical fiber 4. The distance L is determined by the alignment tool 70 in such a way that the surface 94 of the end face 93 of the optical fiber 4 abuts on the first section 25 of the alignment element 7 if the ferrule 3 is mounted on the support member 2. The diameter d of the fiber in FIG. 9 is greater than the diameter of the fiber in FIG. 10. Therefore, the mounted fiber of FIG. 9 projects from the end of the ferrule 3 with a smaller distance L than the optical fiber 4 of FIG. 10.

Tests have shown that a precise alignment in the y- and/or x-direction has a greater effect on performance than in the z-direction. The position of the end face 93 of the optical fiber 4 along the z-direction of the optical path 18 is not so important for an optimal coupling between the optical fiber 4 and the optical component 19, whereby the end face 93 of the optical fiber 4 has to abut on the conical first section 25. The necessary projecting length of the optical fiber 4 is preferably adjusted in a predetermined range with the alignment tool 70.

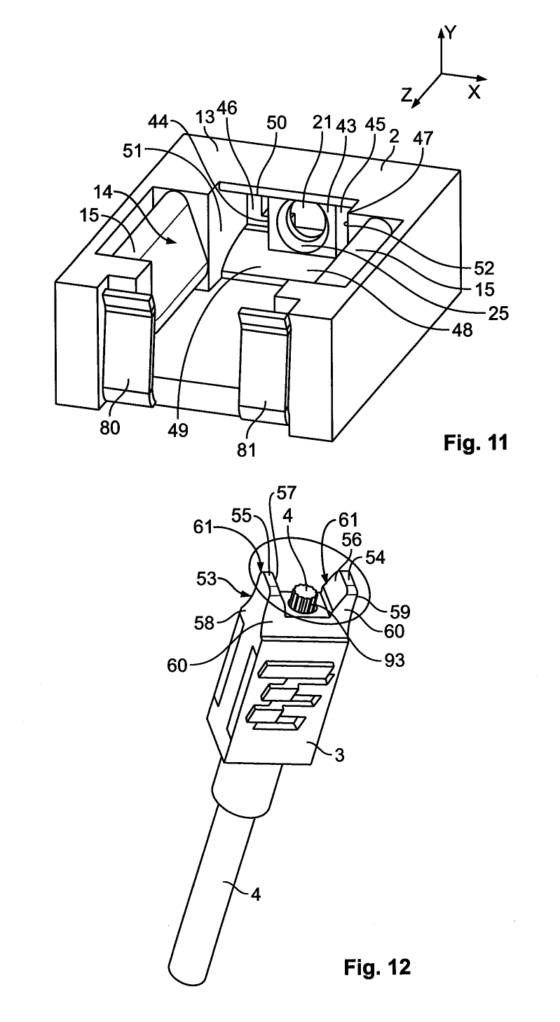

In the embodiment shown of FIG. 11, a support member 2 includes a housing 13 with a ferrule recess 14. In a front side of the housing 13, the bore 21 is disposed in a projecting block 43. The bore 21 includes a conical first section 25. Depending on the used embodiment, there may also be a second section as explained with the embodiment of FIG. 5. However, in the embodiment shown, there is only a conical first section 25. The projecting block 43 includes at two opposite outer sides a first and a second guiding face 44, 45. The first and the second guiding face 44, 45 define a conical or tapered section of the projecting block 43. The width of the projecting block 43 increases in the insertion direction of the optical fiber 4, i.e. the z-direction. The first and the second guiding face 44, 45 confine a first and a second guiding recess 46, 47, which are disposed at opposite sides of the projecting block 43. The projecting block 43 is disposed in a third guiding recess 48 of a front section of the housing 13. The third guiding recess 48 is confined by a first and second face 49, 50, which confine an upper and a lower side of a conical or tapered section of the third guiding recess 48 and an upper and a lower side of a conical or tapered section of the first and the second guiding recesses 46, 47. The first and the second faces 49, 50 (i.e. conical) are arranged perpendicular to the first and the second guiding faces 44, 45 and extend into the first and the second guiding recesses 46, 47. The side faces of the third guiding recess 48 are confined by a third and a fourth side face 51, 52.

The third guiding recess 48 is arranged adjacent to the ferrule recess 14. The third guiding recess 48 passes over in the first and the second guiding recess 46, 47 at two opposite sides of the projecting block 43. The first and the second faces 49, 50 and the first guiding face 44 and the second guiding face 45 dispose first rough alignment mechanism for attaining a rough alignment of the ferrule 3. The third guiding recess 48 includes a conical or tapered shape in the y-plane, whereby the width of the guiding recess 48 decreases in the insertion direction of the optical fiber 4. The first and second guiding recesses 46, 47 include a conical or tapered shape in the x-plane, whereby the widths of the first and second guiding recesses 46, 47 decrease in the insertion direction of the optical fiber 4, i.e. the z-direction. The support member 2 includes a second and a third spring 80, 81, which may be used for biasing the ferrule 3 and the optical fiber 4 in the direction of the alignment element 7. By means of the second and the third spring, the optical fiber 4 may be pushed on the conical first section 25, thus achieving a precise alignment of the optical fiber 4 in the z-plane referring to an optical path 18. Depending on the embodiment, the second and the third spring 80, 81 may be omitted because the position of the ferrule 3 may be fixed by the clamping element 15. The third guiding recess 48 passes over to the first and second guiding recess 46, 47.

In a further embodiment, the optical fiber connector 1 includes a resilient clamping element 15 that is connected with the support member 2 and that fixes the ferrule 3 in a detachable manner on the support member 2. The clamping element 15 provides a simple and cheap means for fixing the ferrule 3.

FIG. 12 shows a ferrule 3 with an alignment head 53 with second rough alignment mechanism. The alignment head 53 is arranged at a front side of the ferrule 3 and includes in a center the end face 93 of the optical fiber 4. At opposite sides with respect to the optical fiber 4, there are two pins 54, 55, which are used for a rough alignment of the ferrule 3 during the insertion in the support member 2. The first and the second pin 54, 55 project from the center of the ferrule 3 at a larger distance than the optical fiber 4. Thus, the first and second pin 54, 55 protect the end face 93 of the optical fiber 4 along the whole length. The first and the second pin 54, 55 include inner inclined faces 56, 57, which are arranged as outwards inclined faces with respect to the direction of the end face 93 of the optical fiber 4 defining a conical or tapered space between the inner faces 56, 57. The first and second inner faces 56, 57 cover the whole width of the respective first and second pin 54, 55. At opposite sides to the inner faces 56, 57, there are outer faces 58, 59 that confine the first and the second pin 54, 55. The outer faces 58, 59 are extended side faces of the ferrule 3. The ferrule 3 has basically the shape of a cuboid with two parallel side faces, two parallel upper and lower faces, a back face and a front face, whereby at the front face of the ferrule 3, the first and the second pin 54, 55 are disposed. The first and the second pin 54, 55 extend from the front face of the alignment head 53 in the longitudinal axis of the optical fiber 4.

The first and the second pin 54, 55 are disposed on an upper and a lower side face 60, 61. The opposite upper and lower side faces 60, 61 of the first and the second pin 54, 55 are inclined with respect to each other in the direction of the end face 93 of the optical fiber 4, thus providing a conical shape of the first and the second pin 54, 55. By providing the conical shape, the end face 93 of the optical fiber 4 is precisely aligned during the insertion of the surface 94 of the end face 93 of the optical fiber 4 in the bore 21.

By inserting the ferrule 3 in the support member 2, the first and the second pin 54, 55 are moved through the third guiding recess 48 in the first and respectively the second guiding recess 46, 47. The upper side faces 60 and the lower side faces 61 are guided by the first face 49 and the second face 50. The first outer face 58 and the second outer face 59 of the pins 54, 55 are guided by the third and the fourth side face 51, 52. Additionally, the first inner face 56 of the first pin 54 and the second inner face 57 of the second pin 55 are guided by the first guiding face 44 and the second guiding face 45 of the projecting block 43. The design of alignment head 53 of the ferrule 3 and the design of the third, second and first guiding recesses 48, 47, 46 provide a first and a second rough alignment mechanism during the insertion of the ferrule 3 in the support member 2 resulting in rough pre-alignment of the optical fiber 4 with respect to a z-plane of the first section 25.

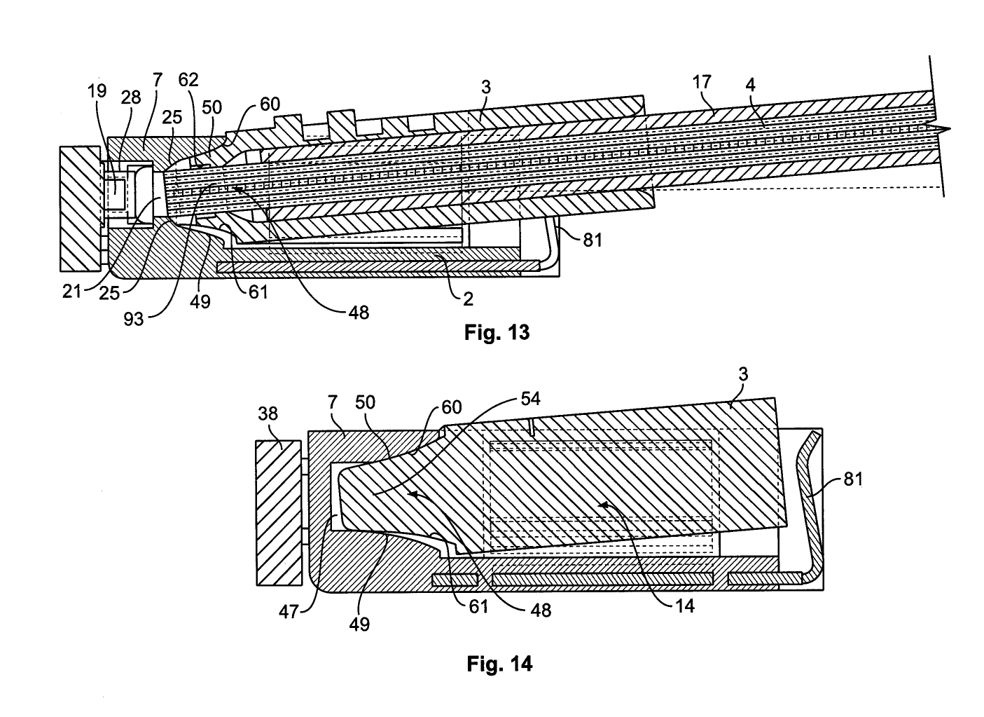

In the pre-mounting position, shown in FIG. 13, the ferrule 3 is pre-aligned by the first and the second faces 49, 50 and the first and the second guiding face 44, 45 (not shown). The first and second faces 49, 50 define a conical or tapered section of the third guiding recess 48 and the first guiding recess 46. In this position, the optical fiber 4 is pre-aligned for the insertion in the first section 25, as shown. Depending on the embodiment, the bore 21 may include only a conical first section 25. The pre-alignment of the ferrule 3 reduces the danger of damaging the optical fiber 4 by inserting the ferrule 3 in the support member 2. In the embodiment shown, the ferrule 3 is fixed on the cladding 17, whereby the optical fiber 4 extends beyond the cladding 17 and extends beyond the front end of the ferrule 3 as shown in FIG. 12. The ferrule 3 includes at the front end face 93 a circumventing recess 62 which surrounds the optical fiber 4 and which allows a more flexible bending of the optical fiber 4 which is useful for a precise alignment during the insertion in the bore 21.

In FIG. 14, the first pin 54 is arranged in the second guiding recess 47, whereby the upper and the lower side faces 60, 61 of the first pin 54 are guided by the first and the second faces 49, 50 defining conical or tapered sections of the third and the first guiding recess 48, 46 in the x-plane.

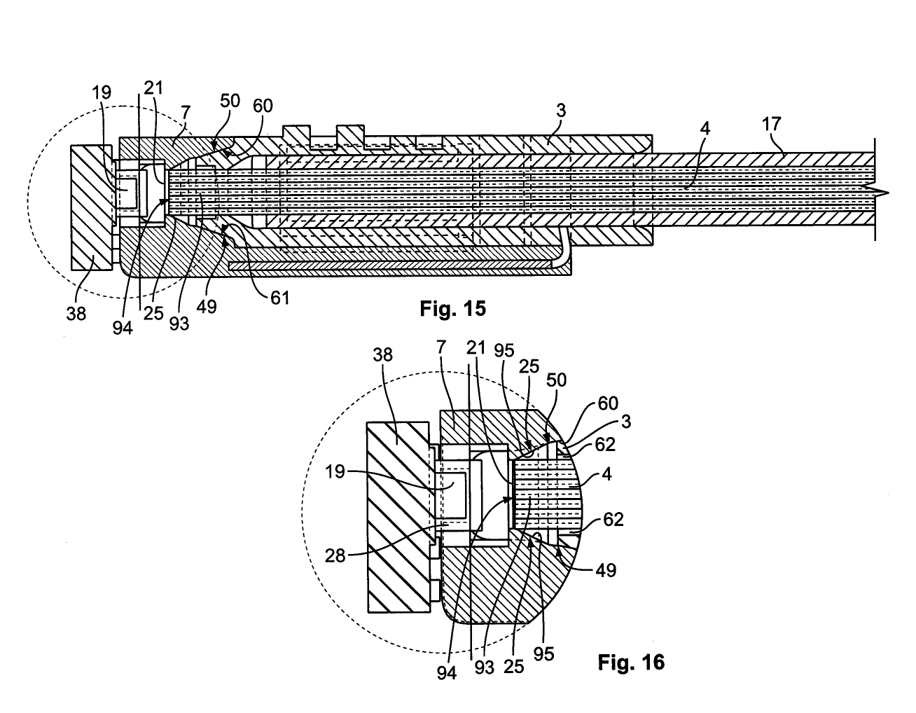

In FIG. 15, the ferrule 3 with an optical fiber 4 is inserted in an end position. The upper side face 60 and the lower side face 61 of the first and the second pin 54, 55 abut against the first and the second faces 49, 50. The optical fiber 4 is in a mounted position, whereby the surface 94 of the end face 93 of the optical fiber 4 is arranged in the conical first section 25 of the bore 21. The shown embodiment depicts a bundle of fibers, whereby each optical fiber 4 includes an end face 93 with a surface 94 which define a common surface of the bundle of fibers.

In FIG. 16, the end of the ferrule 3 is disposed in the third guiding recess 48 and with the first and the second pin 54, 55 and the first and the second guiding recess 46, 47. The surface 94 of the end face 93 of the optical fiber 4 is arranged in the area of the first section 25. The surface 94 of the end face 93 of the optical fiber 4 abuts on the first section 25 with an outer rim 95 of the surface 94 of the end faces of the optical fiber 4. The outer rim 95 has a circular shape. The bundle of fibers may be constructed as a multicore polymer optical fiber.

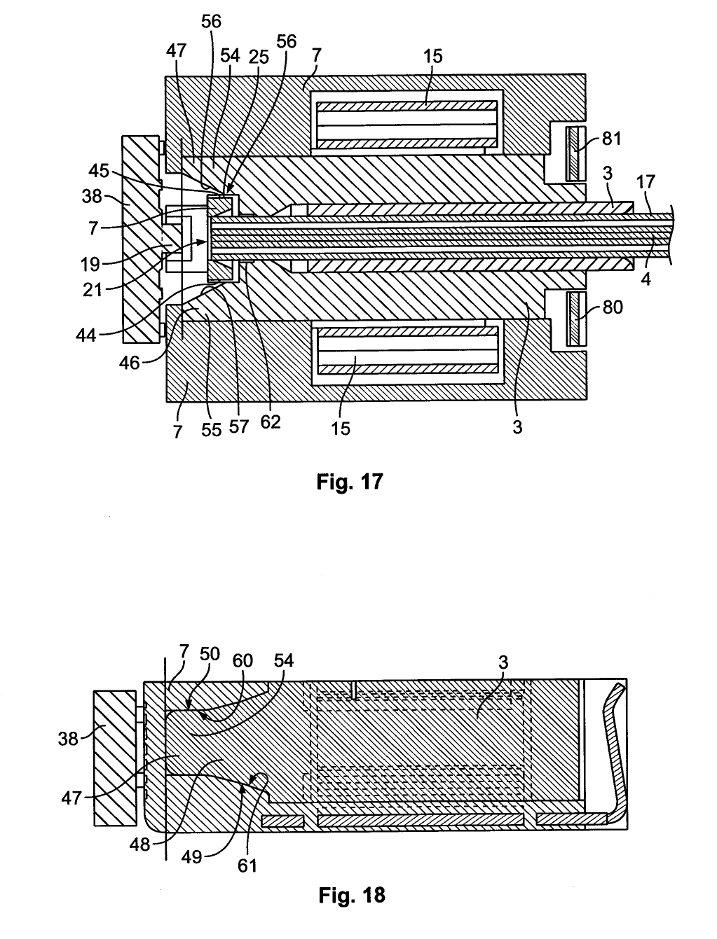

Turning now to FIG. 17, the first and the second pin 54, 55 extend in the first and the second guiding recess 46, 47. Furthermore, the first inner face 56 and the second inner face 57 of the first and, respectively of the second pin 54, 55 lie at the first guiding face 44 and respectively at the second guiding face 45.

FIG. 18 shows a further cross-sectional view in a second x-plane through the first pin 54 that lies with the upper side face 60 and the lower side face 61 against the first and the second guiding face 44, 45 of the second guiding recess 47.

Depending on the embodiment, also one pin 54, 55 might be sufficient for attaining a rough alignment of the optical fiber 4 by the ferrule 3. Furthermore, the guiding faces might have different orientations or different shapes, whereby the function of a pre-alignment of the optical fiber 4 by using the ferrule 3 is also attained.

Furthermore, although the first section 25 may not be precisely shown in a conical shape, it may have a tapered shape with a circular cross-sectional face.

In a further embodiment, the position of the guiding faces may also be behind the end section 29 of the optical fiber 4. Additionally, the pre-alignment of the ferrule 3 may also be attained by guiding faces at the side faces and the upper and the lower faces of the cuboid section of the ferrule 3.

While the embodiments of the present invention have been illustrated in detail, it should be apparent that modifications and adaptations to those embodiments may occur. The scope of the invention is therefore limited only by the following claims.

1. A connector, comprising:
a support member;
a ferrule being fixed to the support member for receiving an optical fiber;
an alignment element connected with the support member and abutting an end face of the optical fiber; and
a guiding face of an opening of the alignment element, the guiding face having a first section with a tapered shape and cross section narrowing in an inserting direction of the end face of the optical fiber and abutting a surface of the end face of the optical fiber.

2. The connector according to claim 1, further comprising an alignment mechanism disposed to align the ferrule relative to a predetermined optical path.

3. The connector according to claim 2, wherein the alignment mechanism is positioned on the ferrule and the support member to align the optical fiber to the alignment element by mounting the ferrule on the support member.

4. The connector according to claim 3, wherein the alignment mechanism aligns the ferrule relative to a plane perpendicular to the predetermined optical path.

5. The connector according to claim 2, wherein the alignment mechanism includes a guiding recess in the support member for receiving an alignment head of the ferrule.

6. The connector according to claim 5, wherein the alignment mechanism includes guiding faces that are arranged on the ferrule and guiding faces that are arranged on the support member.

7. The connector according to claim 2, wherein the alignment mechanism includes two pins at an alignment end of the ferrule directed in an insertion direction of the optical fiber and two guiding recesses in the support member, the pins positioned in the respective guiding recesses in an assembled position of the ferrule.

8. The connector according to claim 6, wherein the alignment mechanism includes two pins at an alignment end of the ferrule directed in an insertion direction of the optical fiber and two guiding recesses in the support member, the pins positioned in the respective guiding recesses in an assembled position of the ferrule.

9. The connector according to claim 1, wherein the opening is a bore opening to an optical component recess in a back side of the support member.

10. The connector according to claim 9, further comprising an optical component at least partially positioned in the optical component recess.

11. The connector according to claim 1, further comprising a recess positioned at a front end face of the ferrule and adjacent to the optical fiber.

12. The connector according to claim 11, wherein the alignment element includes a protruding part positioned in the recess as a rough alignment mechanism for the ferrule.

13. The connector according to claim 1, wherein the end face of the optical fiber protrudes from an alignment end of the ferrule.

14. The connector according to claim 13, the alignment end of the ferrule includes at least one protruding part that protects the optical fiber at one side.

15. The connector according to claim 1, wherein the support member includes a housing with a ferrule recess with an opening in an upper face of the housing, whereby the ferrule is arranged in the ferrule recess of the housing, the ferrule is guided by two opposite walls of the ferrule recess.

16. The connector according to claim 1, wherein the optical fiber includes a core having a bundle of multi-fibers with end faces defining a surface, the surface abuts at least partially with an outer rim on the first section.

17. The connector according to claim 1, whereby the alignment element includes a guiding recess with a conical or tapered shape in an insertion direction of the optical fiber.

18. The connector according to claim 17, wherein a part of the ferrule projects into the guiding recess, the ferrule is aligned by the guiding recess with respect to one or two perpendicular axes.

19. The connector according to claim 18, wherein two guiding recesses are positioned in the alignment element at opposite sides of the opening receiving two projecting parts of the ferrule.

20. The connector according to claim 19, wherein a third guiding recess is positioned in the alignment element, the third guiding recess is in the insertion direction in front of the two guiding recesses and passes over to the two guiding recesses.
